(19) United States
(12) Patent Application Publication
(10) Pub. No.: US 2006/0209289 A1
(43) Pub. Date: Sep. 21, 2006

(54) Exposure apparatus, and device manufacturing method

(75) Inventor: Yasuhiro Fujiwara, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/371,100

(22) Filed: Mar. 9, 2006

(30) Foreign Application Priority Data
Mar. 15, 2005 (JP) 072291/2005(PAT.)

(51) Int. Cl. G03B 27/62

(52) U.S. Cl. 355/75; 355/72

(57) ABSTRACT

Disclosed is an exposure apparatus for exposing a substrate through a reticle, wherein the apparatus includes a clamp having a circumferential protrusion and a pin disposed inside the circumferential protrusion, a reticle stage configured to support the clamp, and an attraction mechanism configured to attract the reticle, placed on the circumferential protrusion, toward the pin.

### FIELD OF THE INVENTION AND RELATED ART

This invention relates to an exposure apparatus having an original stage for holding an original that bears a pattern to be transferred to a substrate.

An example of reticle (original) holding mechanism used in an exposure apparatus will be explained with reference to FIGS. 9, 10A and 10B. FIG. 9 is a schematic view showing a reticle stage as the same is seen in an exposure optical axis direction (Z direction). For better understanding, a reticle is illustrated in perspective (see-through). A reticle denoted at 101 is mounted on a reticle stage denoted at 102, and the reticle stage 102 can be moved for scan drive in Y direction as depicted by an arrow (dash-and-dot line) in the drawing.

The reticle 101 is held (clamped) by the reticle stage 102 through reticle clamps 103.

FIG. 10B is a sectional view taken on a line B-B in FIG. 9. The reticle clamps 103 have vacuum pads 103A adapted to apply vacuum attraction in a direction of an arrow (dash-and-dots line) in the drawing, to thereby hold the reticle.

In the scan drive and during acceleration, as shown in FIG. 10B, a force 103B of acceleration acts on the reticle stage 102. Also, in accordance with the acceleration, an inertia (G) 103C is applied to the reticle 101. Because of these forces, the position of the reticle may disadvantageously be deviated by a few microns to a few nanometers. The reticle 101 and the reticle stage 102 have been relatively positioned with a nanometer order precision. If such positional deviation occurs, the precision of pattern transfer to a wafer (substrate) will be degraded.

FIG. 10C is a sectional view taken on a line C-C in FIG. 9. When a reticle is mounted on the stage, due to the weight of the reticle the edge of each clamp 103 at its exposure region side acts as a fulcrum, as illustrated in the drawing. If in this state the reticle 101 is held by attraction, the attracting force acts on the peripheral end portion of the reticle such that, due to leverage, the reticle 101 may be distorted.

### SUMMARY OF THE INVENTION

It is accordingly an object of the present invention to provide a technique effective to reduce a positional deviation of an original during acceleration/deceleration of a stage as well as distortion of the original due to an original holding force.

In accordance with an aspect of the present invention, to achieve the above object, there is provided an exposure apparatus for exposing a substrate through a reticle, said apparatus comprising: a clamp having a circumferential protrusion and a pin disposed inside said circumferential protrusion; a reticle stage configured to support said clamp; and an attraction mechanism configured to attract the reticle, placed on said circumferential protrusion, toward said pin.

In accordance with another aspect of the present invention, there is provided a device manufacturing method, comprising the steps of: exposing a substrate to light through a reticle, by use of an exposure apparatus as recited above; developing the exposed substrate; and processing the developed substrate to produce a device.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view, showing a general appearance of an exposure apparatus.

FIGS. 2A and 2B are schematic views, respectively, showing a general appearance of a reticle stage.

FIGS. 3A, 3B and 3C show a reticle clamp mechanism, wherein FIG. 3A is a plan view, FIG. 3B is a sectional view taken on a line A-A in FIG. 3A, and FIG. 3C is a sectional view taken on a line B-B in FIG. 3A.

FIGS. 4A and 4B are schematic views, respectively, for explaining the reticle clamp in its non-attracting state and in its attraction process state, respectively.

FIG. 5 is a schematic view taken on the A-A section, for explaining a spike effect of the reticle clamp.

FIG. 6 is a schematic view taken on the B-B section, for explaining the spike effect of the reticle clamp.

FIG. 7 is a flow chart for explaining device manufacturing processes using an exposure apparatus.

FIG. 8 is a flow chart for explaining details of a wafer process in the procedure of FIG. 7.

FIG. 9 is a schematic view of a conventional reticle stage.

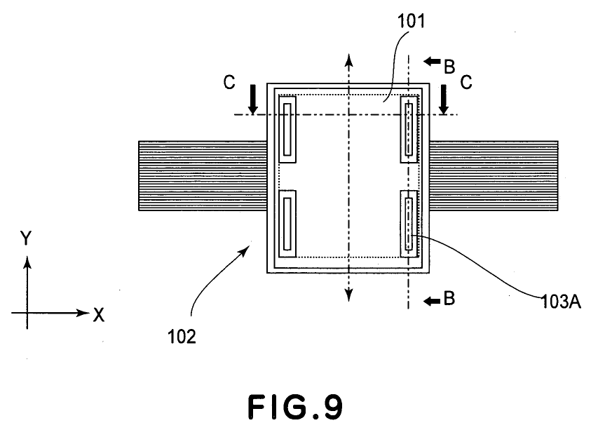

FIGS. 10A and 10B are sectional views, respectively, for explaining a conventional reticle clamp mechanism.

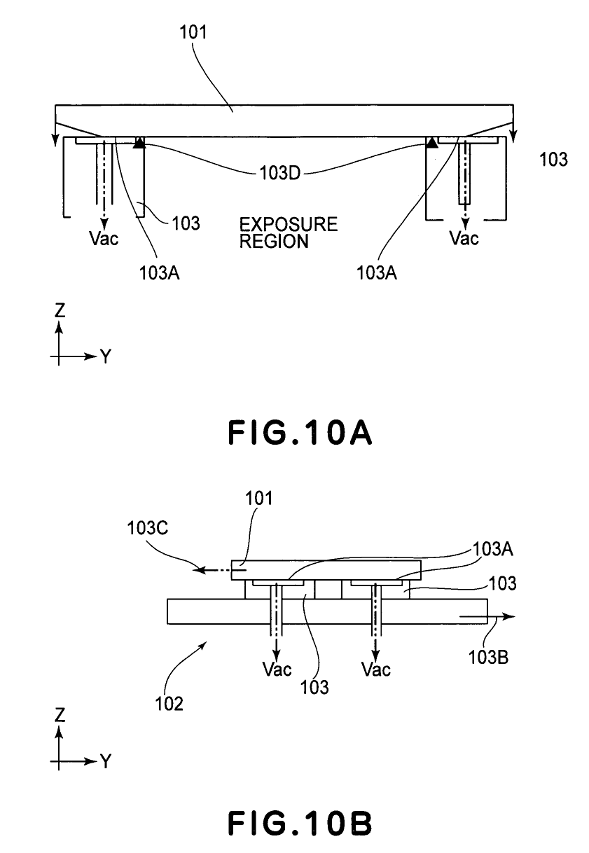

### DESCRIPTION OF THE PREFERRED EMBODIMENTS

Preferred embodiments of the present invention will be described below with reference to the attached drawings. Here, it should be noted that the embodiments to be described below are examples for embodying the present invention, and the structure and function may be modified or changed appropriately in accordance with the structure or any other conditions of a system where the present invention is to be incorporated.

[Embodiment 1]

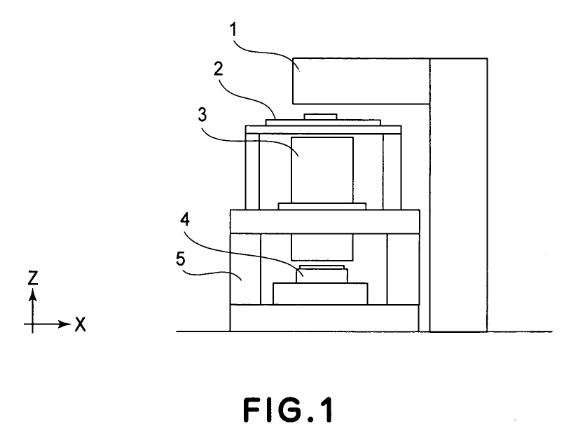

A first embodiment of the present invention will now be explained. FIG. 1 is a schematic view of an exposure apparatus according to the first embodiment of the present invention. An illumination system unit denoted at 1 includes a light source, and an optical element for shaping light from the light source into uniform exposure light. The exposure light emitted from the illumination system unit 1 passes through a reticle (this may be referred to also as “original” or “mask”) which is placed on a reticle stage 2, and a pattern of the reticle is projected by a reduction projection lens 3 and in a reduced scale, upon a wafer which is placed on a wafer stage 4. The reticle stage 2, the projection lens 3 and the wafer stage 4 are supported by a main frame 5 of the exposure apparatus. Here, it should be noted that a general structure of the exposure apparatus such as described above is merely an example, and any other structures may be used.

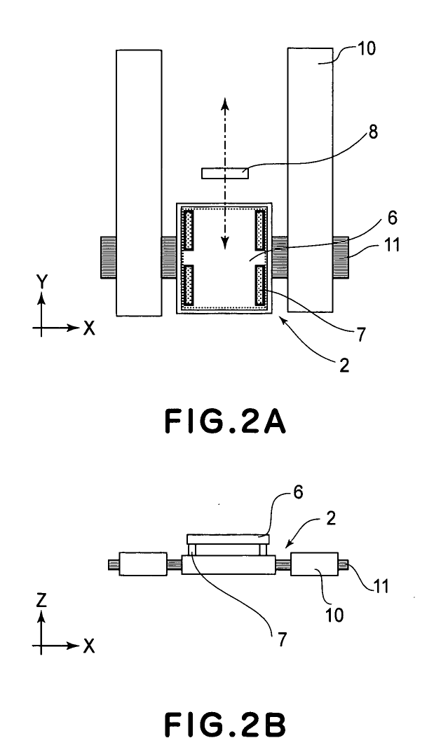

FIG. 2A illustrates the reticle stage 2 as the same is seen in an exposure optical axis direction, that is, Z direction. FIG. 2B is a sectional view of the stage as seen in a scan direction, that is, Y direction. Slit-like exposure light 8 is a light shaped into a slit-like shape as illustrate. The reticle stage 2 and the wafer stage 4 are scanningly moved in synchronism with each other, to expose the wafer through the reticle. The reticle stage 2 is driven by a linear motor which comprises a stator 10 and a movable element 11. A reticle denoted at 6 is held on the reticle stage 2, by means of a reticle clamp mechanism 7.

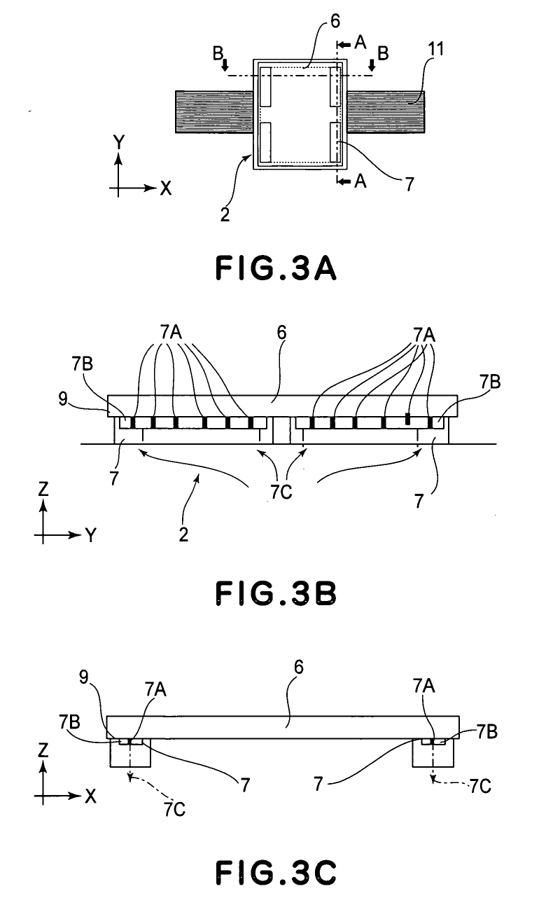

Referring to FIGS. 3A-3C, the manner how the reticle 6 is held by the reticle clamp mechanism 7 will be explained. FIG. 3A is a plan view wherein the reticle 6 is held on the top surface of the reticle clamps 7. FIG. 3B is a sectional view in a scan direction (i.e., A-A section), showing the state of clamping. FIG. 3C is a sectional view in a non-scan direction (i.e., B-B section), showing the stage of clamping.

Each reticle clamp 7 comprises a holding surface (circumferential protrusion) 9, a plurality of pins 7A, an attracting groove 7B provided around the plural pins, and vacuum suction means (exhausting means) 7C for vacuum sucking (exhausting) a space (a gas therein) defined by the attracting groove 7B. The circumferential protrusion 9 and the plurality of pins 7A may be made of the same material. The vacuum suction means 7C may comprise a tube and a vacuum pump (not shown) connected to the tube. Each pin 7A is designed to support the reticle at its free end face. By applying vacuum suction to the space defined by the groove 7B, the reticle 6 can be held by attraction upon the free end faces (top faces) of the pins and the holding surface 9, while keeping the state as the same has been positioned with respect to X, Y and Z directions.

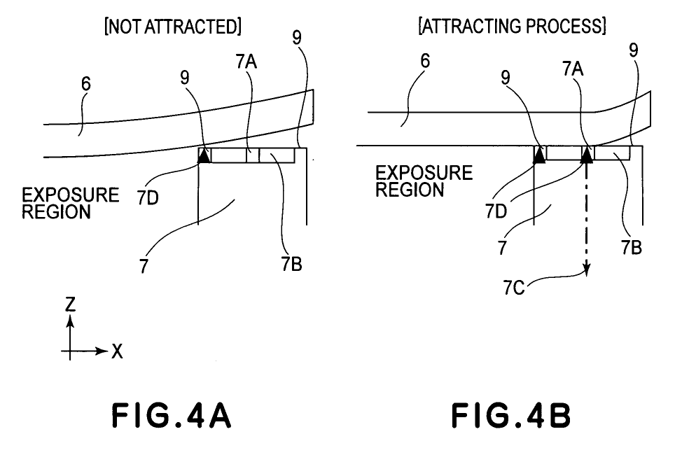

FIGS. 4A and 4B are sectional views, respectively, which correspond to the B-B section of FIG. 3C.

FIG. 4A illustrates a non-attracted state of the reticle. More specifically, after being positioned with respect to X, Y and Z directions, the reticle 6 is mounted on the reticle clamps 7. In the non-attracted state of the reticle 6, that is, in the initial state of the same, the reticle 6 is flexed due to the gravity thereof. Therefore, the reticle 6 is in contact with one edge of each reticle clamp 7 which is at its exposure region side (exposure optical axis side). The end portion of the reticle 6 is therefore out of contact with the clamp.

When vacuum suction is applied by the vacuum suction means 7C, as shown in FIG. 4B, the reticle 6 starts to be in contact with the pin 7A. This results in an increase of fulcrums 7D where the reticle 6 contacts the reticle clamp 7.

If the number of fulcrums 7D increases, the distance between the fulcrum of leverage and the point of application of the attracting force is shortened. Therefore, production of distortion as the reticle 6 is held by attraction can be reduced significantly.

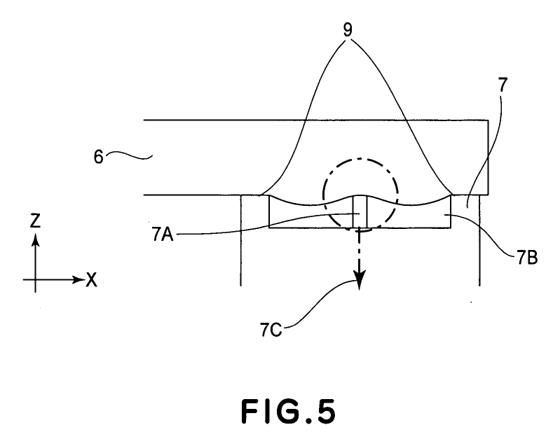

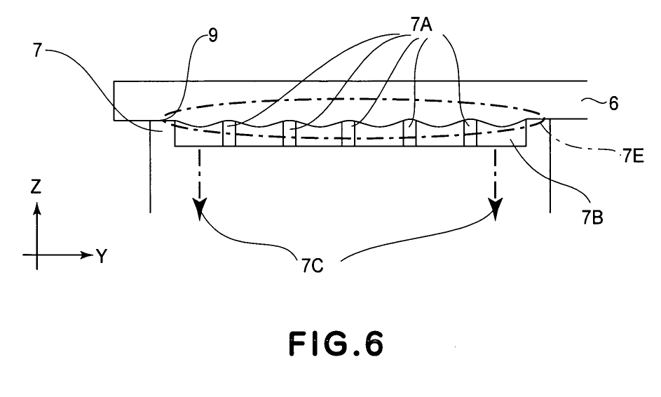

On the other hand, as shown in FIGS. 5 and 6, when the reticle is held by attraction, the reticle 6 may be deformed as like it is sunk into between the pins 7A. A surface irregularity shape created by such deformation may occur at plural locations on the reticle 6 surface contacted to the pins 7A, to produce a spike effect illustrated at 7E in the drawing.

Generally, as regard microscopic factors of friction force, a surface irregularity factor and an agglutination factor are known. In the former, the more the irregularity on the contact surface is, the larger the friction is. In the latter, the stronger the coupling of atoms at the contact surface is, the larger the friction is. The spike effect described above is based on the surface irregularity factor mentioned above. As the surface irregularity increases at the time of attraction holding, the friction force is enlarged thereby. This provides an advantageous effect of reducing a shift or positional deviation of the reticle of an amount of few microns to few nanometers, which otherwise might be caused conventionally. Such spike effect can reduce the positional deviation with respect to X and Y directions.

Although in this embodiment the reticle is held by vacuum attraction, similar advantageous effects are attainable when the reticle is held by an electrostatic attraction force.

[Embodiment 2]

Next, an embodiment of a semiconductor device manufacturing method which uses an exposure apparatus according to the first embodiment described above, will be explained as a second embodiment of the present invention.

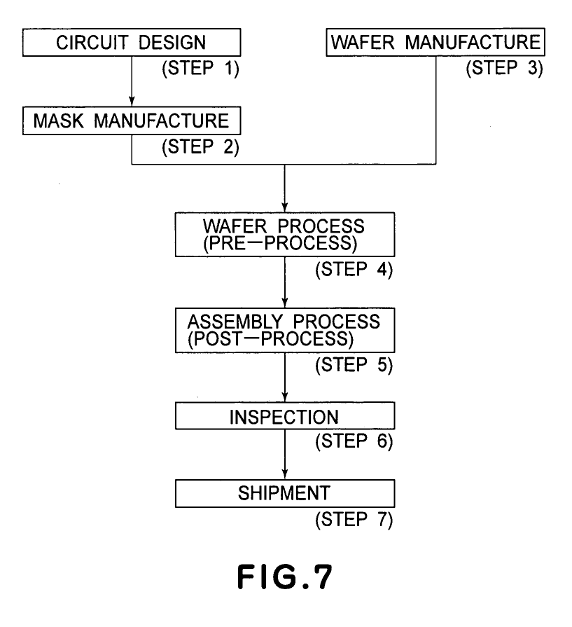

FIG. 7 is a flow chart for explaining the procedure of manufacturing various microdevices such as semiconductor chips (e.g., ICs or LSIs), liquid crystal panels, CCDs, thin film magnetic heads or micro-machines, for example. Step 1 is a design process for designing a circuit of a semiconductor device. Step 2 is a process for making a mask on the basis of the circuit pattern design. Step 3 is a process for preparing a wafer by using a material such as silicon. Step 4 is a wafer process which is called a pre-process wherein, by using the thus prepared mask and wafer, a circuit is formed on the wafer in practice, in accordance with lithography. Step 5 subsequent to this is an assembling step which is called a post-process wherein the wafer having been processed at step 4 is formed into semiconductor chips. This step includes an assembling (dicing and bonding) process and a packaging (chip sealing) process. Step 6 is an inspection step wherein an operation check, a durability check an so on, for the semiconductor devices produced by step 5, are carried out. With these processes, semiconductor devices are produced, and they are shipped (step 7).

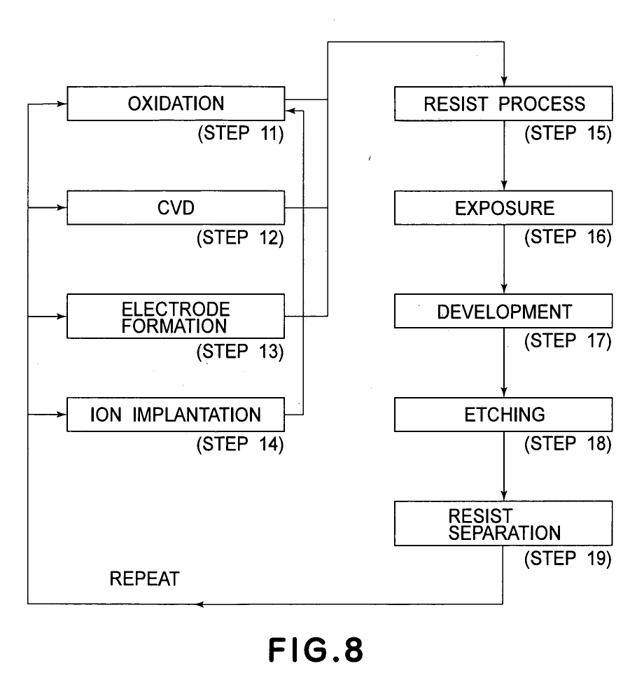

The wafer process at step 4 in FIG. 7 includes the following processes (FIG. 8). Namely, Step 11 is an oxidation process for oxidizing the surface of a wafer. Step 12 is a CVD process for forming an insulating film on the wafer surface. Step 13 is an electrode forming process for forming electrodes upon the wafer by vapor deposition. Step 14 is an ion implanting process for implanting ions to the wafer. Step 15 is a resist process for applying a resist (photosensitive material) to the wafer. Step 16 is an exposure process for printing, by exposure, the circuit pattern of the mask on the wafer through the exposure apparatus described above. Step 17 is a developing process for developing the exposed wafer. Step 18 is an etching process for removing portions other than the developed resist image. Step 19 is a resist separation process for separating the resist material remaining on the wafer after being subjected to the etching process. By repeating these processes, circuit patterns are superposedly formed on the wafer.

As described above, through the device manufacturing processes using an exposure apparatus according to the first embodiment, very fine circuit patterns can be produced.

In accordance with the embodiments of the present invention as described hereinbefore, a positional deviation of an original due to acceleration/deceleration of a stage, as well as distortion of the original to be caused by a force for holding the original, can be reduced effectively. A high-precision exposure apparatus including such original holding mechanism can be provided as well.

While the invention has been described with reference to the structures disclosed herein, it is not confined to the details set forth and this application is intended to cover such modifications or changes as may come within the purposes of the improvements or the scope of the following claims.

This application claims priority from Japanese Patent Application No. 2005-072291 filed Mar. 15, 2005, for which is hereby incorporated by reference.

What is claimed is:

1. An exposure apparatus for exposing a substrate through a reticle, said apparatus comprising:
a clamp having a circumferential protrusion and a pin disposed inside said circumferential protrusion;
a reticle stage configured to support said clamp; and
an attraction mechanism configured to attract the reticle, placed on said circumferential protrusion, toward said pin.

2. An apparatus according to claim 1, wherein said attraction mechanism includes a vacuum pump for discharging a gas out of a space encircled by said circumferential protrusion.

3. An apparatus according to claim 1, wherein said attraction mechanism is configured to attract the reticle on the basis of an electrostatic attraction force.

4. An apparatus according to claim 1, wherein said clamp is configured to hold the reticle in association with both of said circumferential protrusion and said pin.

5. An apparatus according to claim 1, wherein said circumferential protrusion and said pin are made of the same material.

6. An apparatus according to claim 1, wherein said exposure apparatus is a scan exposure apparatus.

7. A device manufacturing method, comprising the steps of:
exposing a substrate to light through a reticle, by use of an exposure apparatus as recited in claim 1;
developing the exposed substrate; and
processing the developed substrate to produce a device.
